(19) United States
(12) Patent Application Publication
(10) Pub. No.: US 2024/0109755 A1
(43) Pub. Date: Apr. 4, 2024

(54) DUPLEX ELEVATOR

(71) Applicants: Hyundai Motor Company, Seoul (KR); Kia Corporation, Seoul (KR); Base and Power City Corp., Seoul (KR)

(72) Inventors: Donguk Lee, Seoul (KR); Sungsu Park, Seoul (KR)

(21) Appl. No.: 18/464,652

(22) Filed: Sep. 11, 2023

Related U.S. Application Data
(60) Provisional application No. 63/411,129, filed on Sep. 29, 2022.

(51) Int. Cl. B66B 11/02; B66B 1/42; B66B 3/00; B66B 11/00

(52) U.S. Cl. CPC B66B 11/0226; B66B 1/425; B66B 3/002; B66B 11/0045; B66B 2201/306

(57) ABSTRACT

An embodiment elevator includes a cage located on a hoistway and a raising/lowering driving device configured to raise and lower the cage in an up-down direction. The cage includes a first chamber having a first space as an inner space and a second chamber having a second space as an inner space, the second chamber is coupled to an upper or lower side of the first chamber, and a height of the first chamber is greater than a height of the second chamber in the up-down direction.

### CROSS-REFERENCE TO RELATED APPLICATIONS

This application claims the benefit of U.S. Provisional Application No. 63/411,129, filed on Sep. 29, 2022, which application is hereby incorporated herein by reference.

### TECHNICAL FIELD

Exemplary embodiments relate to a duplex elevator.

### BACKGROUND

Elevators are generally provided in a path formed long in a vertical direction and transport passengers or cargo to designated locations while moving up and down in the path. A cage of each of the elevators is connected to a main rope and raised or lowered by using a pulley on which the main rope is hung.

The cage has a space formed therein to transport passengers or cargo. An elevator made by dividing this space into several regions or connecting several cages to operate together is referred to as a double deck elevator. The double deck elevator may maximize transportation efficiency by using a method in which one of upper and lower spaces stops only on odd-numbered floors and the other space stops only on even-numbered floors.

Also, as described above, the elevator is not only used to transport passengers, but also may be used to transport cargo or robots. Depending on objects to be transported, the appropriate shapes and suitable environments required for the elevators may be different from each other. However, once an elevator is installed, it is difficult to replace the elevator. Therefore, there is a need for an elevator having a universal form that may be appropriately applied to various objects to be transported without replacement and provide an appropriate environment for various objects to be transported.

### SUMMARY

Exemplary embodiments of the present invention provide a duplex elevator that may be used for various objects to be transported.

An exemplary embodiment of the present invention provides an elevator including a cage located on a hoistway and a raising/lowering driving unit configured to raise and lower the cage, wherein the cage includes a first chamber having a first space as an inner space and a second chamber having a second space as an inner space and coupled to an upper or lower side of the first chamber, and wherein a height of the first chamber is greater than a height of the second chamber in an up-down direction

### BRIEF DESCRIPTION OF THE DRAWINGS

The accompanying drawings, which are included to provide a further understanding of embodiments of the invention and are incorporated in and constitute a part of this specification, illustrate embodiments of the invention, and together with the description serve to explain the principles of embodiments of the invention.

FIG. 1 is a view conceptually showing a state in which an elevator according to an exemplary embodiment of the present disclosure is provided in a building.

FIG. 2 is a perspective view showing a shape of a cage according to an exemplary embodiment of the present disclosure.

FIGS. 3 and 4 are views conceptually showing a state of each of chambers of a cage arriving at platforms together with components of the elevator according to an exemplary embodiment of the present disclosure.

FIG. 5 is a view conceptually showing a state in which a plurality of cages of an elevator according to an exemplary embodiment of the present disclosure are used in various forms.

FIG. 6 is a perspective view conceptually showing a state in which a cage according to an exemplary embodiment of the present disclosure further includes a third chamber.

### DETAILED DESCRIPTION OF ILLUSTRATIVE EMBODIMENTS

Hereinafter, exemplary embodiments of the present disclosure are described in more detail with reference to the accompanying drawings. When reference numerals are given to elements in each drawing, it should be noted that the same elements are designated by the same reference numerals if possible although they are shown in different drawings. Also, in describing exemplary embodiments of the present disclosure, a detailed description of related known configurations or functions is omitted when it is determined that the understanding of the exemplary embodiments of the present disclosure is hindered by the detailed description.

In describing components of exemplary embodiments of the present disclosure, terms such as first, second, A, B, (a), and (b) may be used. These terms are only used to distinguish one component from other components, and the characteristics, orders, or sequences of the corresponding components are not limited by the terms. When one component is described as being “connected,” “coupled,” or “linked” to another component, this component may be directly connected, coupled, or linked to another component, but it should be understood that other components may be “connected,” “coupled,” or “linked” between these components.

As used herein, the front, rear, left, right, up, and down directions are defined for convenience of description, and these directions may be determined relative to a direction in which an elevator is located. The front-rear direction, left-right direction, and up-down direction may be perpendicular to each other.

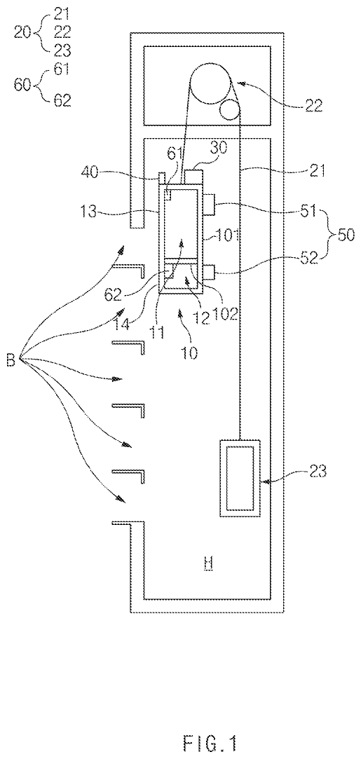

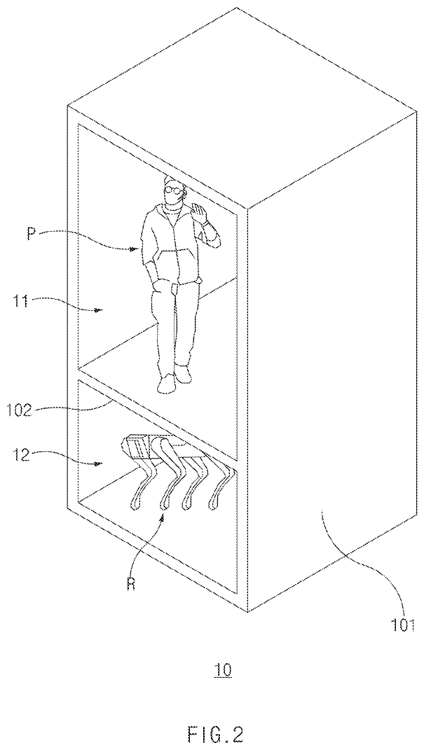

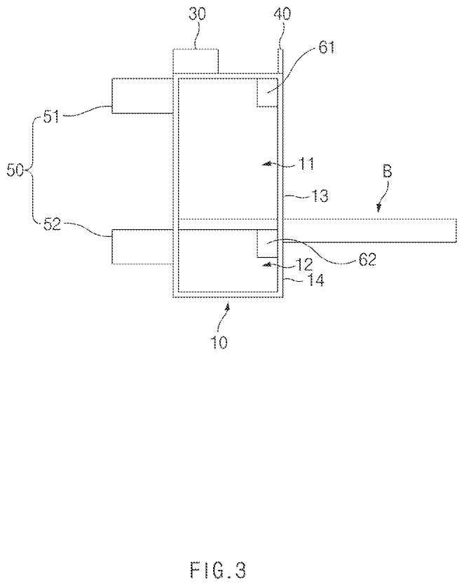

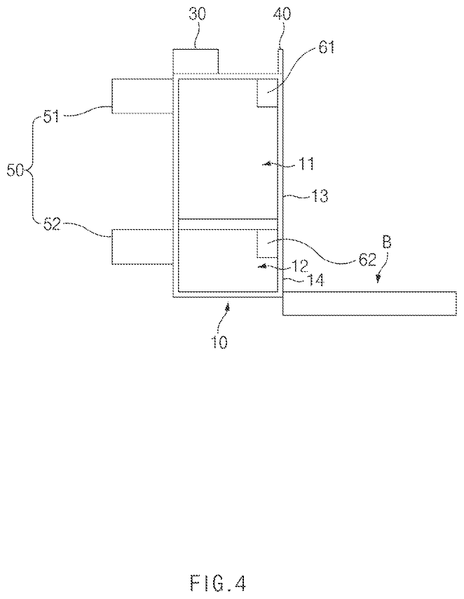

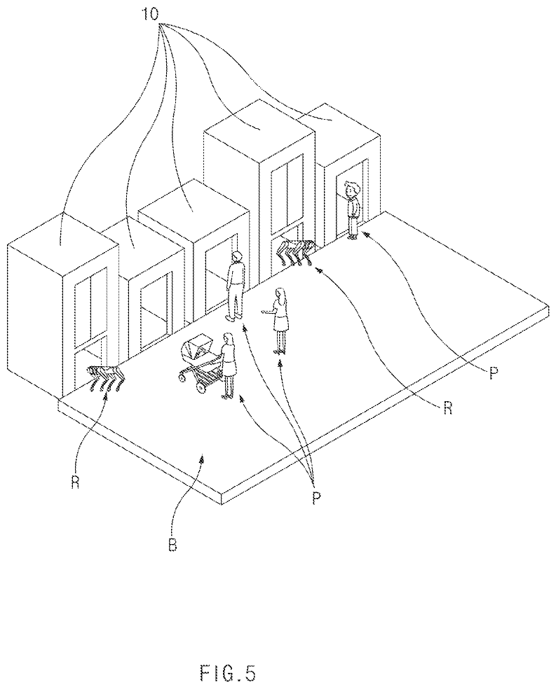

FIG. 1 is a view conceptually showing a state in which an elevator according to an exemplary embodiment of the present disclosure is provided in a building. FIG. 2 is a perspective view showing a shape of a cage 10 according to an exemplary embodiment of the present disclosure. FIGS. 3 and 4 are views conceptually showing a state of each of chambers of the cage 10 arriving at platforms B, together with components of the elevator according to an exemplary embodiment of the present disclosure. FIG. 5 is a view conceptually showing a state in which a plurality of cages 10 of an elevator according to an exemplary embodiment of the present disclosure are used in various forms.

Referring to the drawings, the elevator according to an exemplary embodiment of the present disclosure includes a cage 10 and a raising/lowering driving unit 20.

### Cage 10

The cage 10 has an inner space for loading passengers P or cargo and may move up and down in a hoistway H. The cage 10 has an entrance that is open toward each of the platforms B so that the cage 10 is connected to the platform B while the inner space thereof is in an open state. In order to open and close the entrance of the cage 10, the cage 10 may include cage doors 13 and 14.

The platform B is connected to the hoistway H, which is a passage of the elevator, and serves to wait for the passengers P or cargo to board the elevator. Therefore, for the safety of the passengers P or cargo, the entrance of the platform B is blocked by an elevator door and may be selectively opened and closed. The elevator door of the platform B opens the entrance of the platform B in a state in which the cage 10 of the elevator stops at a position corresponding to the height of the platform B and the passengers P or cargo may get in or out of the elevator, and the elevator door closes the entrance while the cage 10 is moving. The movement of the cage doors 13 and 14 may be linked with the movement of the elevator door. That is, when the cage doors 13 and 14 are opened, the elevator door may also be opened. When the cage doors 13 and 14 are closed, the elevator door may also be closed. The number of elevator doors may correspond to the number of cage doors 13 and 14.

The cage doors 13 and 14 may slide to open and close the entrance of the cage 10. The cage doors 13 and 14 may slide in the left-right direction. There are two states, such as a closed state in which the two cage doors 13 and 14 approach each other to close the entrance of the cage 10 and an open state in which the two cage doors 13 and 14 move away from each other and escape from the entrance of the cage 10. However, one of the cage doors 13 and 14 may slide or telescopically expand and contract to form a closed state and an open state. While being raised or lowered, the cage 10 maintains a closed state in which the entrance is closed. When stopped at a height corresponding to the platform B such that the passengers P or cargo may get in or out of the elevator, the cage 10 may be switched to an open state in which the entrance is opened.

The cage 10 includes a first chamber 11 having a first space as an inner space and a second chamber 12 having a second space as an inner space. The second chamber 12 may be coupled to an upper or lower side of the first chamber 11. The second chamber 12 is illustrated as being provided on the lower side of the first chamber 11 in the drawings, but the location thereof is not limited thereto.

The height of the first chamber 11 is greater than the height of the second chamber 12 in the up-down direction. Accordingly, the first chamber 11 may be suitable for a passenger P to board, and the second chamber 12 may be suitable for a robot R or cargo to board.

The cage 10 may include a case 101 and a partition plate 102. The case 101 may be formed in a box shape with an open front side and have an inner space. The partition plate 102 may be provided inside the case 101 to partition the inner space of the case 101 into the first chamber 11 and the second chamber 12. As illustrated in the drawings, when the first chamber 11 is located above the second chamber 12, the passenger P may stand on the partition plate 102. The partition plate 102 may be formed in a plate shape perpendicular to the up-down direction. The cage 10 may include a partition-driving unit that is coupled to the partition plate 102 and the case 101 to adjust the height of the partition plate 102. The height of the partition plate 102 inside the case 101 is adjusted by driving the partition-driving unit, and accordingly, the heights of the first chamber 11 and the second chamber 12 in the up-down direction may be adjusted. The partition-driving unit may include a component that receives power, such as a motor or an actuator to generate power, and a lead screw or a chain lift that converts the received power into a driving force for linear motion and transmits the driving force to the partition plate 102. However, a method of driving the partition-driving unit is not limited thereto. The first chamber 11 and the second chamber 12 may be configured as separate modules and then coupled to each other.

The cage doors 13 and 14 may include a first door 13 and a second door 14. The first door 13 is electrically connected to a processor 30 described below and is coupled to the first chamber 11 to open and close the entrance of the first chamber 11. The second door 14 is electrically connected to the processor 30 and is coupled to the second chamber 12 to open and close the entrance of the second chamber 12. Each of the first door 13 and the second door 14 may include a cover that moves to open and close the entrance and a cover driver for sliding of the cover.

The cage 10 may include a manipulation unit. The passenger P may input a command for operating the elevator by manipulating buttons in the manipulation unit.

### Raising/Lowering Driving Unit 20

The raising/lowering driving unit 20 includes a component for raising or lowering the cage 10. The raising/lowering driving unit 20 includes a main rope 21, a power transmission unit 22, and a balance weight 23, and may drive the cage 10 in such a way that the main rope 21 is driven by the power transmission unit 22 to raise and lower the cage 10. The raising/lowering driving unit 20 may include a rail and a linear motor that enable ascent and descent in a magnetic levitation method. The driving method thereof is not limited thereto.

The main rope 21 includes a rope for raising and lowering the cage 10. The main rope 21 has one end connected to the cage 10 and the other end connected to the balance weight 23. The main rope 21 may be connected to the upper end of the cage 10 and the upper end of the balance weight 23.

The power transmission unit 22 includes a device, on which the main rope 21 is hung, so as to drive the main rope 21. The power transmission unit 22 is provided above the hoistway H to raise and lower the cage 10 to a corresponding floor according to the button manipulation of the passenger P. The power transmission unit 22 may include a motor, which generates certain power, that is, a rotational force, by using a power source applied from the outside, and a main sheave, which is connected to the motor and rotated by the rotational force of the motor to raise and lower the cage 10. The main rope 21 may be hung on the main sheave. The main rope 21 may be driven by rotation of the main sheave. The main rope 21 may be wound around the main sheave when the main sheave rotates.

The other end of the main rope 21 is connected to the balance weight 23. The cage 10 and the balance weight 23 may be arranged at positions opposite to each other with respect to the power transmission unit 22. The cage 10 is positioned adjacent to the platform B so that the cage doors 13 and 14 may face the platform B. The balance weight 23 may be located far from the platform B. Therefore, when the cage 10 ascends, the balance weight 23 may descend. Also, when the balance weight 23 ascends, the cage 10 may descend. The balance weight 23 may keep the cage 10 in balance.

One end of a compensation rope may be connected to the lower end of the cage 10. The compensation rope may be hung on a compensation sheave located at the lower end of the hoistway H, and the other end of the compensation rope may be connected to the balance weight 23, thereby maintaining the tension of the main rope 21.

### Environment-Checking Unit 60

The elevator according to an exemplary embodiment of the present disclosure may include an environment-checking unit 60. The environment-checking unit 60 may be electrically connected to the processor 30. The environment-checking unit 60 may include a first environment-checking unit 61 installed in the first chamber 11 to check the environment of the inner space of the first chamber 11 and a second environment-checking unit 62 installed in the second chamber 12 to check the environment of the inner space of the second chamber 12.

The environment factors adjustable by each of the environment-checking units 60 may include at least one of temperature, humidity, illuminance, air composition, pressure in the inner spaces, or any combination thereof. In other to check these environmental factors, the environment-checking unit 60 may include at least one of a temperature sensor for sensing the temperature of the inner space, a humidity sensor for sensing the humidity of the inner space, an illuminance sensor for sensing the illuminance of the inner space, a mass analyzer for sensing the composition of the air in the inner space, a pressure sensor for sensing the pressure of the inner space, or any combination thereof. However, the sensors provided in the environment-checking unit 60 and the environmental factors obtainable by these sensors are not limited thereto.

### Transportation Object-Checking Unit 40

The elevator according to an exemplary embodiment of the present disclosure may include a transportation object-checking unit 40. The transportation object-checking unit 40 is installed in the cage 10 to check objects to be transported (hereinafter, referred to as transportation objects) that enter the first chamber 11 and the second chamber 12. As illustrated in the drawings, the transportation object-checking unit 40 may be located on the upper side of the case 101 of the cage 10 or may be located one by one in each chamber. The transportation object-checking unit 40 may be electrically connected to the processor 30.

The transportation object-checking unit 40 may include an optical sensor capable of acquiring an image of a transportation object using electromagnetic waves. The optical sensor may include a camera using infrared or visible light. On the basis of an image of a transportation object obtained by the transportation object-checking unit 40, the processor 30 may check the type of the transportation object through image processing. That is, on the basis of the information obtained by the transportation object-checking unit 40, the processor 30 may check information about the transportation object, such as, whether the transportation object is a passenger P, a cargo, or a robot R, what the gender and age of the passenger P are, what the type of the robot R is, or the like.

### Environment-Creating Unit 50

The elevator according to an exemplary embodiment of the present disclosure may include an environment-creating unit 50. The environment-creating unit 50 may adjust the environment of each chamber. The environment-creating unit 50 includes a first environment-creating unit 51 for adjusting the environment of the inner space of the first chamber 11 and a second environment-creating unit 52 for adjusting the environment of the inner space of the second chamber 12. The second environment-creating unit 52 may adjust the environment of the inner space of the second chamber 12 in a different manner from the environment of the inner space of the first chamber 11. Different transportation objects may board the first chamber 11 and the second chamber 12. Therefore, when the environments of the first chamber 11 and the second chamber 12 are adjusted according to respective transportation objects, the inner space of the first chamber 11 and the inner space of the second chamber 12 may have different environments.

The environment factors adjustable by the first environment-creating unit 51 and the second environment-creating unit 52 may include at least one of temperature, humidity, illuminance, air composition, pressure in the inner spaces, or any combination thereof. In order to adjust these environmental factors, each of the environment-creating units 50 may include an air conditioner capable of changing the air composition using temperature adjustment and ventilation, a humidifier and a dehumidifier capable of adjusting the humidity, a lighting device for adjusting the intensity of illumination, or the like. However, the components for adjusting the environmental factors are not limited thereto. Each environment-creating unit 50 is electrically connected to the processor 30, and each of the environmental factors may be adjusted under the control of the processor 30.

### Processor 30

The elevator according to an exemplary embodiment of the present disclosure may include the processor 30. The processor 30 may be electrically connected to the raising/lowering driving unit 20 and may also be electrically connected to other components of the elevator. The processor 30 may include a central processing unit (CPU) or the like as a component including an element capable of logic operations for performing control commands. The processor 30 is connected to various components of the elevator according to an exemplary embodiment of the present disclosure. The processor 30 may transmit a signal according to a control command to each of the components and may be connected to various sensors or acquisition units to receive acquired information in the form of a signal. The processor 30 may be electrically connected to each of the components, and thus, the processor 30 may communicate with the components by being connected to the components via wires or by being connected to a wireless communication module capable of wireless communication.

The elevator according to an exemplary embodiment of the present disclosure may include a wireless communication module. The wireless communication module may be electrically connected to the processor 30 and may communicate wirelessly with a communication module of the robot R, etc. The wireless communication module may wirelessly communicate with the manipulation unit of the platform B for each of the floors.

The elevator further includes a storage medium, and thus, control commands executed by the processor 30 may be stored and utilized in the storage medium. The storage medium may include devices, such as a hard disk drive (HDD), a solid state drive (SSD), a server, a volatile medium, and a nonvolatile medium, but the types of the storage medium are not limited thereto. In addition, data required for the processor 30 to perform tasks may be further stored in the storage medium.

The processor 30 may be installed in the cage 10. However, the processor 30 may be provided at another location in the hoistway H other than the cage 10.

The cage 10 may be called from any one of the platforms B provided on the floors. The passenger P may call the cage 10 by manipulating a manipulation unit provided at the platform B in each of the floors, and the robot R located at the platform B or inside the cage 10 may call the cage 10 using the communication module. Also, the passenger P located in a cage 10 may make the cage 10 to be called from a platform B on a specific floor by manipulating the manipulation unit provided in the cage 10.

The processor 30 may be set to control the raising/lowering driving unit 20 when the cage 10 is called from a certain platform B, so that the first chamber 11 is located at a height corresponding to a height of the platform B calling the cage 10 as illustrated in FIG. 3, and then the second chamber 12 is located at the height corresponding to the height of the platform B calling the cage 10 as illustrated in FIG. 4. Therefore, the passenger P may get in or out of the first chamber 11, and then the robot R or cargo may get in or out of the second chamber 12.

The processor 30 may be set to control the raising/lowering driving unit 20 when the cage 10 is called from a certain platform B by the robot R via the wireless communication module but not called by the passenger P, so that the second chamber 12 is located at the height corresponding to the height of the platform B. That is, when only the robot R needs to get in or out of the cage 10, the passenger P may not need to get in or out. Therefore, only the second chamber 12 may arrive at the platform B without the arrival of the first chamber 11.

The processor 30 may be set to open the first door 13 and close the second door 14, when the cage 10 is stopped in a state in which the first chamber 11 is located at a height corresponding to a height of a certain platform B. Similarly, the processor 30 may be set to close the first door 13 and open the second door 14, when the cage 10 is stopped in a state in which the second chamber 12 is located at a height corresponding to a height of a certain platform B. The processor 30 may be set to close both the first door 13 and the second door 14 when neither the first chamber 11 nor the second chamber 12 is located at a height corresponding to a height of a certain platform B. Accordingly, the door of the chamber placed at a position not corresponding to the height of the platform B is closed, and thus, the passenger P or the robot R may be safely positioned in the chamber.

The processor 30 may be set to control the first environment-creating unit 51 on the basis of the environment inside the first chamber 11, which is checked by the first environment-checking unit 61, and to control the second environment-creating unit 52 on the basis of the environment inside the second chamber 12, which is checked by the second environment-checking unit 62. The processor 30 may check whether values of the environmental factors checked by each environment-checking unit 60 are within a numerical range of appropriate environmental factors required for each chamber stored in the storage medium. When it is confirmed that a value of a certain environmental factor among the environmental factors checked by each environment-checking unit 60 is out of range, a corresponding environment-creating unit 50 may be controlled so that the numerical value of the corresponding environmental factor falls within the numerical range of the appropriate environmental factor. For example, when it is confirmed by the first environment-checking unit 61 that the temperature of the first chamber 11 is lower than a lower limit of an appropriate temperature range required in the first chamber 11, the processor 30 may use an air conditioner of the first environment-creating unit 51 to supply high-temperature air to the inner space of the first chamber 11 so that the temperature of the first chamber 11 falls within the appropriate temperature range.

The processor 30 may be set to control the first environment-creating unit 51 on the basis of a transportation object, which enters the first chamber 11 and is checked by the transportation object-checking unit 40, and to control the second environment-creating unit 52 on the basis of a transportation object, which enters the second chamber 12 and is checked by the transportation object-checking unit 40. That is, the processor 30 may create different environments, depending on what types of transportation objects enter each chamber. For example, when a robot R operating optimally at a high temperature enters the second chamber 12 and when a robot R operating optimally at a low temperature enters the second chamber 12, the processor 30 may allow the second chamber 12 to have inner spaces at different temperatures by using the second environment-creating unit 52.

As described above, depending on what type of transportation object boards each of the chambers and what the environment of each of the chambers is like, environments may be individually created. Therefore, it is possible to operate the elevator efficiently.

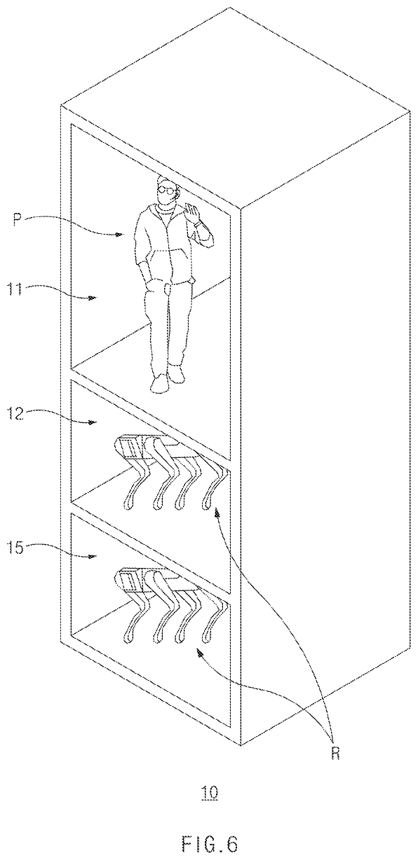

FIG. 6 is a perspective view conceptually showing a state in which a cage 10 according to an exemplary embodiment of the present disclosure further includes a third chamber 15.

Referring to the drawing, the cage 10 of an elevator according to an exemplary embodiment of the present disclosure may further include the third chamber 15. The third chamber 15 may have a third space as an inner space and may be coupled to an upper side of one, which is positioned on the upper side, of a first chamber 11 and a second chamber 12 or coupled to a lower side of the other one of the first chamber 11 and the second chamber 12. The third chamber 15 may have the same shape and size as the second chamber 12, but may have a different shape and size. In the drawing, the third chamber 15 is coupled to the lower side of the second chamber 12, but the locations and shapes thereof are not limited thereto.

The elevator may include a third environment-checking unit and a third environment-creating unit which are arranged in the third chamber 15. The third environment-checking unit and the third environment-creating unit may operate similarly to the environment-checking unit 60 and the environment-creating unit 50, respectively, which are described above.

As described above, when modularized chambers are connected to each other, it is possible to construct a duplex elevator having at least two or three floors as illustrated in the drawing.

Accordingly, the single duplex elevator may be appropriately used for the various objects to be transported.

Even though all the components constituting exemplary embodiments of the present disclosure have been described as being combined as one body or operating in combination, the embodiments of the present disclosure are not necessarily limited to the exemplary embodiments. That is, within the scope of the objectives of the embodiments of the present disclosure, all the components may be selectively combined into one or more and then operated. Also, terms such as “include,” “constitute,” or “have” described above may mean that the corresponding components may be included unless explicitly described to the contrary, and thus should be construed as further including other components rather than excluding other components. Unless otherwise defined, all terms including technical or scientific terms have the same meanings as those generally understood by a person skilled in the art to which the present disclosure pertains. Terms used generally, such as terms defined in dictionaries, should be interpreted as having the same meaning as in an associated technical context, and should not be understood abnormally or as having an excessively formal meaning unless defined apparently in the present disclosure.

The technical ideas of embodiments of the present disclosure have been described merely for illustrative purposes, and those skilled in the art appreciate that various changes and modifications are possible without departing from the essential features of embodiments of the present disclosure. Therefore, the exemplary embodiments of the present disclosure are to be considered illustrative and not restrictive, and the technical idea of the embodiments of the present disclosure is not limited to the foregoing embodiments. The protective scope of the embodiments of the present disclosure is defined by the appended claims, and all technical ideas within their equivalents should be interpreted as being included in the scope of the embodiments of the present disclosure.

What is claimed is:

1. An elevator comprising:
a cage located on a hoistway, wherein the cage comprises:
a first chamber having a first space as an inner space; and
a second chamber having a second space as an inner space, the second chamber being coupled to an upper or lower side of the first chamber, wherein a height of the first chamber is greater than a height of the second chamber in an up-down direction; and
a raising/lowering driving device configured to raise and lower the cage in the up-down direction.

2. The elevator of claim 1, further comprising:
a first environment-creating device configured to adjust an environment of the inner space of the first chamber; and
a second environment-creating device configured to adjust an environment of the inner space of the second chamber in a different manner from the environment of the inner space of the first chamber.

3. The elevator of claim 2, further comprising:
a first environment-checking device installed in the first chamber and configured to check the environment of the inner space of the first chamber; and
a second environment-checking device installed in the second chamber and configured to check the environment of the inner space of the second chamber.

4. The elevator of claim 3, further comprising a processor electrically connected to the first environment-creating device, the second environment-creating device, the first environment-checking device, and the second environment-checking device, wherein the processor is configured to:
control the first environment-creating device based on the environment checked by the first environment-checking device; and
control the second environment-creating device based on the environment checked by the second environment-checking device.

5. The elevator of claim 2, further comprising:
a transportation object-checking device installed in the cage and configured to check first and second objects to be transported that enter the first chamber and the second chamber, respectively; and
a processor electrically connected to the first environment-creating device, the second environment-creating device, and the transportation object-checking device, wherein the processor is configured to:
control the first environment-creating device based on the first object that enters the first chamber and is checked by the transportation object-checking device; and
control the second environment-creating device based on the second object that enters the second chamber and is checked by the transportation object-checking device.

6. The elevator of claim 2, wherein environment factors controllable by the first environment-creating device and the second environment-creating device comprise at least one of temperature, humidity, illuminance, air composition, pressure in the inner spaces, or any combination thereof.

7. The elevator of claim 1, wherein the cage further comprises a third chamber that has a third space as an inner space, the third chamber being coupled to an upper side of an uppermost one of the first chamber and the second chamber or being coupled to a lower side of a lowermost one of the first chamber and the second chamber.

8. The elevator of claim 1, wherein the second chamber is located below the first chamber.

9. The elevator of claim 1, further comprising:
a processor electrically connected to the raising/lowering driving device; and
a wireless communication module electrically connected to the processor and configured to provide wireless communication with a communication module of a robot, wherein the processor is configured to control the raising/lowering driving device in response to a call from a platform by the robot via the wireless communication module such that the second chamber is located at a height corresponding to a height of the platform.

10. The elevator of claim 1, wherein the cage comprises:
a case having an inner space;
a partition plate having a plate shape perpendicular to the up-down direction and located inside the case to partition the inner space of the case into the first chamber and the second chamber; and
a partition-driving device coupled to the partition plate and the case and configured to adjust a height of the partition plate.

11. An elevator comprising:
a cage located on a hoistway, wherein the cage comprises:
a first chamber having a first space as an inner space; and
a second chamber having a second space as an inner space, the second chamber being coupled to an upper or lower side of the first chamber, wherein a height of the first chamber is greater than a height of the second chamber in an up-down direction;
a raising/lowering driving device configured to raise and lower the cage in the up-down direction; and
a processor electrically connected to the raising/lowering driving device, wherein the processor is configured to control the raising/lowering driving device in response to a call for the cage to a platform such that the first chamber is located at a height corresponding to a height of the platform and then the second chamber is located at the height corresponding to the height of the platform.

12. The elevator of claim 11, wherein the cage comprises:
a first door electrically connected to the processor and coupled to the first chamber to open and close an entrance of the first chamber; and
a second door electrically connected to the processor and coupled to the second chamber to open and close an entrance of the second chamber.

13. The elevator of claim 12, wherein the processor is configured to:
open the first door and close the second door when the first chamber is located at the height corresponding to the height of the platform; and
close the first door and open the second door when the second chamber is located at the height corresponding to the height of the platform.

14. The elevator of claim 13, wherein the processor is configured to close the first door and the second door when neither the first chamber nor the second chamber is located at the height corresponding to the height of the platform.

15. The elevator of claim 11, further comprising:
a first environment-creating device configured to adjust an environment of the inner space of the first chamber; and
a second environment-creating device configured to adjust an environment of the inner space of the second chamber in a different manner from the environment of the inner space of the first chamber.

16. The elevator of claim 15, further comprising:
a first environment-checking device installed in the first chamber and configured to check the environment of the inner space of the first chamber; and
a second environment-checking device installed in the second chamber and configured to check the environment of the inner space of the second chamber.

17. The elevator of claim 16, wherein the processor is electrically connected to the first environment-creating device, the second environment-creating device, the first environment-checking device, and the second environment-checking device, and wherein the processor is configured to:
control the first environment-creating device based on the environment checked by the first environment-checking device; and
control the second environment-creating device based on the environment checked by the second environment-checking device.

18. The elevator of claim 15, further comprising a transportation object-checking device installed in the cage and configured to check first and second objects to be transported that enter the first chamber and the second chamber, respectively, wherein the processor is electrically connected to the first environment-creating device, the second environment-creating device, and the transportation object-checking device, and wherein the processor is configured to:
control the first environment-creating device based on the first object that enters the first chamber and is checked by the transportation object-checking device; and
control the second environment-creating device based on the second object that enters the second chamber and is checked by the transportation object-checking device.

19. The elevator of claim 11, further comprising a wireless communication module electrically connected to the processor and configured to provide wireless communication with a communication module of a robot, wherein the processor is configured to control the raising/lowering driving device in response to a second call from a second platform by the robot via the wireless communication module such that the second chamber is located at a height corresponding to a height of the second platform.

20. The elevator of claim 11, wherein the cage comprises:
a case having an inner space;
a partition plate having a plate shape perpendicular to the up-down direction and located inside the case to partition the inner space of the case into the first chamber and the second chamber; and
a partition-driving device coupled to the partition plate and the case and configured to adjust a height of the partition plate.
